(19) United States
(12) Patent Application Publication
(10) Pub. No.: US 2013/0201190 A1
(43) Pub. Date: Aug. 8, 2013

(54) SYSTEMS AND METHODS FOR DISCLOSING TARGET ELEMENTS IN HIGH DEFINITION IMAGES

(71) Applicants: Rongkai Zhao, Kildeer, IL (US); Eui-Hong Han, Hawthorn Woods, IL (US)

(72) Inventors: Rongkai Zhao, Kildeer, IL (US); Eui-Hong Han, Hawthorn Woods, IL (US)

(73) Assignee: SEARS BRANDS, LLC, Hoffman Estates, IL (US)

(21) Appl. No.: 13/364,460

(22) Filed: Feb. 2, 2012

(51) Int. Cl. G06T 1/00

(52) U.S. Cl. 345/428

(57) ABSTRACT

High definition images are utilized in marketing, gaming, retail, e-commerce, multi-channel retail, mobile, tablet and/or social applications. A system displays the high definition image in its entirety, and in various states wherein portions of the high definition image are magnified. The various states show details of the portions of the high definition image that were not previously apparent. The system allows users to look for and detect certain target elements in the high definition image. These target elements may be used for gaming and/or marketing purposes.

### FIELD OF THE DISCLOSURE

The present disclosure generally relates to hiding and revealing target elements within a high definition image for marketing, gaming, retail, e-commerce, multi-channel retail, mobile, tablet and/or social applications. More particularly, systems and methods for disclosing target elements in high definition images.

### BACKGROUND

There exists in the art methods for generating high definition images such as, for example, gigapixel images. A gigapixel image is a digital image bitmap comprising at least 1 billion pixel elements, however high definition images may also comprise less than 1 billion pixel elements. Generally, a high definition image is generated by collecting a set of images depicting various portions of a scene, and then assembling the images in order to create a high definition image. The set of images depicting various portions of a scene may be collected using a robotic platform, such as a GigaPan panorama head (available from Gigapan Systems) in combination with a digital camera, and/or the user may manually collect the set of images using a digital camera. The set of images may be assembled into a high definition image using software that exists in the art, and/or may be manually assembled to create a high definition image.

There also exists in the art viewing software and websites that allow users to explore high definition images by examining different portions of the high definition image. Using the viewing software, users are able to magnify portions of the high definition image, revealing details that were previously not apparent. The background systems and methods identified herein, are incorporated herein by reference in their entirety.

Adding elements to certain portions of a high definition image is also known in the art. These additional elements may be, for example, markers or icons, and may be placed strategically in a landscape at the time the set of images depicting various portions of a scene is being collected, and/or additional elements may be digitally added to the collected images before the images are assembled into a high definition image. For example, a user may position a marker or icon in a certain position in a landscape, prior to collecting images of the landscape. In another example, a user may collect images of a scene, and later embed a marker or icon in one or more of the images that were collected.

While applications using high definition images have been utilized for viewing purposes, the current disclosure utilizes high definition images with intentionally concealed and revealed target elements for marketing, gaming, retail, e-commerce, multi-channel retail, mobile, tablet and/or social applications.

### SUMMARY

In accordance with this and other needs, the following generally discloses systems and methods for utilizing a high definition image in marketing, gaming, retail, e-commerce, multi-channel retail, mobile, tablet and/or social applications. Such a method allows a system to utilize a high definition image by displaying the high definition image in its entirety, and in various reveal states wherein portions of the high definition image are magnified. In these magnified states, users may view details of portions of the high definition image that were not previously apparent. The system allows users to look for and detect certain target elements in the high definition image. These target elements may be used for marketing, gaming, retail, e-commerce, multi-channel retail, mobile, tablet and/or social purposes.

A better appreciation of the objects, advantages, features, and properties of the disclosed systems and methods will be obtained from the following detailed description and accompanying drawings, which set forth illustrative examples that are indicative of the various ways in which the principles described hereinafter may be employed.

### BRIEF DESCRIPTION OF THE DRAWINGS

For a better understanding of the present disclosure, reference may be made to various examples shown in the attached drawings.

FIG. 1 illustrates in block diagram form components of an example, online, gaming, and/or retail, computer network environment.

FIGS. 2A and 2B illustrate in block diagram form one example of the system utilizing high definition images in accordance with the present disclosure.

FIGS. 3-30 illustrate example screenshots of a system for disclosing target elements in high definition images in accordance with the present disclosure.

### DETAILED DESCRIPTION

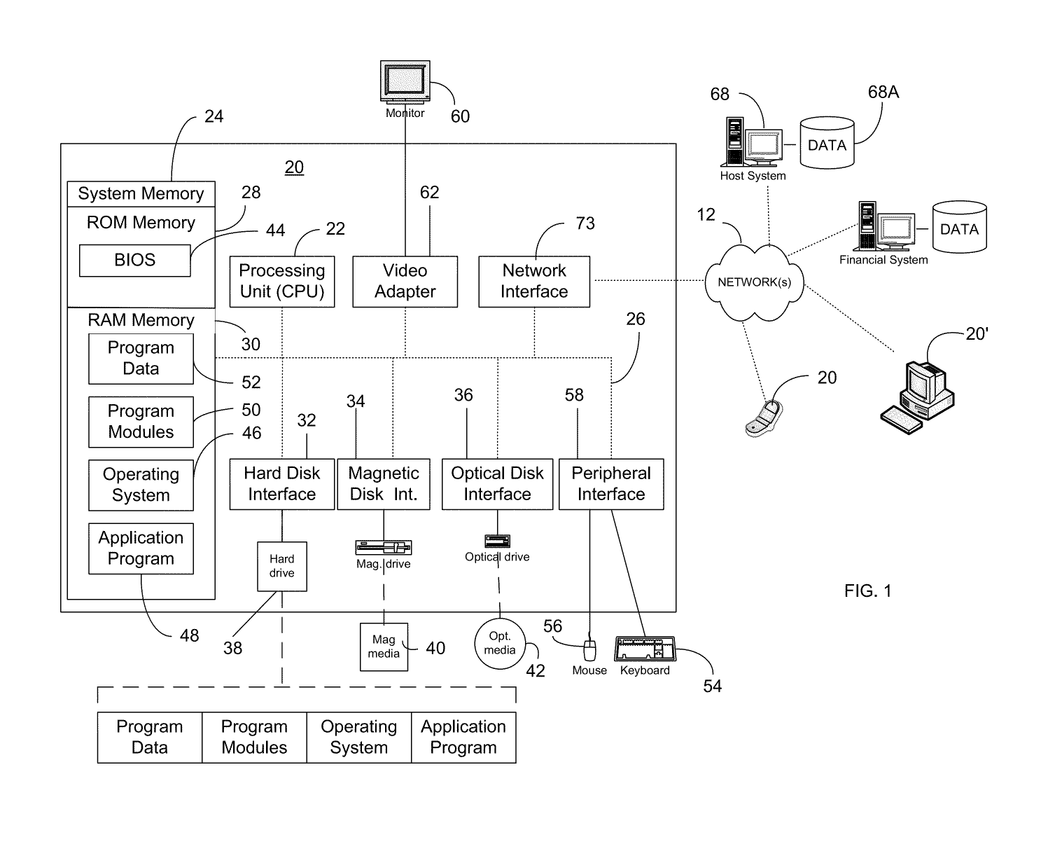

With reference to the figures, the following describes various example systems and methods for disclosing target elements in high definition images. To this end, a processing device 20, illustrated in the exemplary form of a computer system, is provided with executable instructions to, for example, provide a means for a user, e.g., a consumer, customer, etc., to access an organization system server 68 and, among other things, interact with a system for disclosing target elements in high definition images. Generally, the computer executable instructions reside in program modules which may include routines, programs, objects, components, data structures, etc., that perform particular tasks or implement particular abstract data types. Accordingly, those of ordinary skill in the art will appreciate that the processing device 20 illustrated in FIG. 1 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those of ordinary skill in the art will further appreciate that other types of non-transitory computer readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As noted, the processing device 20 may also utilize logical connections to one or more remote processing devices, such as the organization system server 68 having associated data repository 68A. In this regard, while the organization system server 68 has been illustrated in the exemplary form of a computer, it will be appreciated that the organization system server 68 may, like processing device 20, be any type of device having processing capabilities. Again, it will be appreciated that the organization system server 68 need not be implemented as a single device but may be implemented in a manner such that the tasks performed by the organization system server 68 are distributed amongst a plurality of processing devices/databases located at different geographical locations and linked through a communication network. Additionally, the organization system server 68 may have logical connections to other third party systems via the network 12 and, via such connections, will be associated with data repositories that are associated with such other third party systems. Such third party systems may include, without limitation, systems of banking, credit, or other financial institutions, systems of third party providers of goods and/or services, systems of shipping/delivery companies, etc.

For performing tasks as needed, the organization system server 68 may include many or all of the elements described above relative to the processing device 20. In addition, the organization system server 68 may generally include executable instructions for, among other things, embedding target elements within portions of a high definition, displaying a high definition image in its entirety, allowing a user to magnify certain portions of a high definition image, and allowing users to look for and detect certain target elements, and revealing target elements within the high definition image.

Communications between the processing device 20 and the organization system server 68 may be exchanged via a further processing device, such as a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the non-transitory memory storage device(s) of the vendor system server 68.

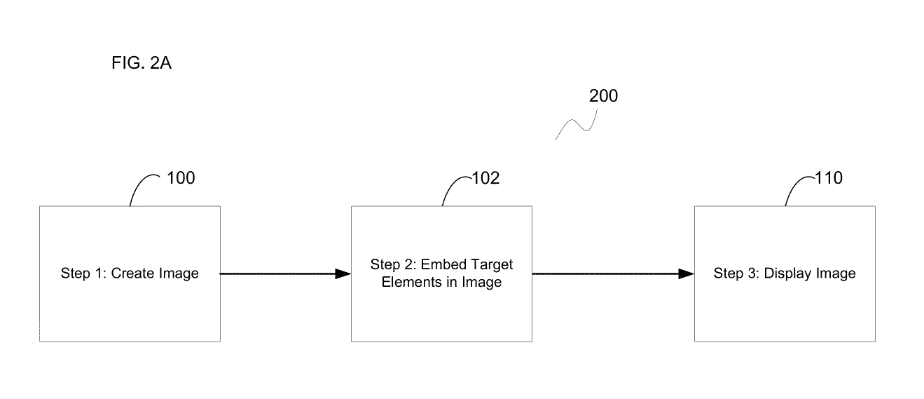

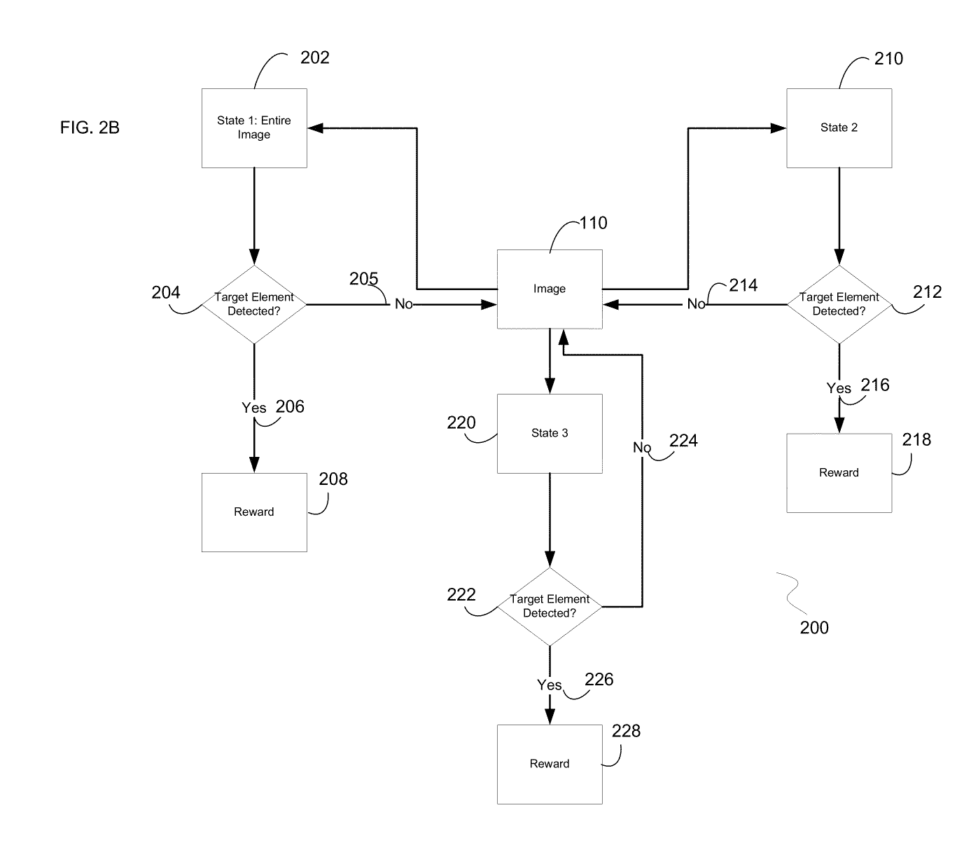

Referring to FIG. 2A, there is illustrated a general schematic of a system 200 for disclosing target elements in high definition images. In the illustrated example, a system 200 creates a high definition image 100. Without limitation, one of ordinary skill in the art will recognize that the image may be created manually, using a camera apparatus, using computer software, etc. Moreover, one of ordinary skill in the art will recognize that the high definition image 110 may depict a geographical landscape, an urban landscape, an interior setting, a fictional setting, a drawing and/or any other suitable subject. Next, the system 200 embeds a target element in the high definition image 102. Without limitation, one of ordinary skill in the art will recognize that the system 200 may add one or more target elements. The target element(s) may comprise a marker, such as a textual marker, a visual marker, or a code, a coupon, an icon, a famous figure, a described situation, and any other suitable elements and/or any combination of the above. One of ordinary skill in the art will also recognize that the target element may be embedded manually as the high definition image 100 is created, or the target element may be embedded after the high definition image 100 is created. Next, the system 200 displays the high definition image 110, which contains the target element(s) added in block 102. The system 200 may display the high definition image 110 on a processing device 20, such as a personal computer, a mobile device, a cellular phone, a personal digital assistant (PDA), a retail kiosk, and/or a physical medium using, such as, for example, the Internet, an internal network, or a social network. Further, the system 200 may display the high definition image 110 to a single user, or several users via the network 12, such as an internet connection, computer network, cellular network, and/or data network.

Referring to FIG. 2B, there is illustrated a general schematic of an example system 200 for disclosing target elements in high definition images 110. In the illustrated example, the system 200 displays the high definition image in various states. As we stated previously, the system 200 may display the high definition image 110 on a processing device 20, such as a personal computer, a mobile device, a cellular phone, a personal digital assistant (PDA), a retail kiosk, and/or a physical medium using, such as, for example, the Internet, an internal network, or a social network. At block 202, the system 200 displays the entire high definition image 110, such that substantially the entire length and width of the high definition image 110 is viewable.

After the system 200 displays the entire high definition image 110 in the first state 202, the user(s) determines whether a target element is detected in the displayed high definition image 110 at block 204. As described above, the target element may be a marker, such as a textual marker, a visual marker, or a code, a coupon, an icon, a famous figure, a described situation, and any other suitable elements and/or any combination of the above. The user(s) may determine whether the target element is present by visually analyzing the high definition image 110, or digitally processing the image using image recognition software, and/or any other means including diagnostic software.

If the user(s) detects the target element, at block 204, the system 200 may reward the user at block 208. The reward provided at block 208 may comprise, providing a free product or service, discount for certain products or services, points, and/or any other suitable reward. The system may end the application, direct the user(s) to a different high definition image, or direct the user(s) to identify additional target element(s) in the high definition image 110.

If the user does not detect the additional element at block 204, the system may re-display the image 110. The system 200 may subsequently display the high definition image 110 in a second state, as shown at block 210. In the second state 210, the system displays and magnifies one or more portions of the high definition image 110, such that details of the high definition image 110 that were not readily available in the first state 202 are now viewable. The portion of the high definition image that is displayed in the second state 210, may be selected by the user(s) or by the system. As will be appreciated by one of ordinary skill in the art, the second state may be triggered automatically by the system, in response to input from the user(s), such as a mouse click, a keystroke, gesture, or activation of a touch-sensitive surface, in response to the system's pre-set instructions, and/or any other appropriate trigger.

After the system 200 displays the high definition image in the second state 210, the user(s) determines whether a target element is detected in the displayed portion(s) of the high definition image 110 at block 212. Again, the user(s) may determine whether the target element is present by visually analyzing the image, or digitally processing the image using image recognition software and/or any other means, including diagnostic software.

If the user detects the target element, at block 212, the system 200 may reward the user at block 218. The reward provided at block 218 may comprise, providing a free product or service, discount for certain products or services, points, and/or any other suitable reward. Subsequently, the system 200 may end the application, direct the user(s) to a different high definition image, or direct the user(s) to identify additional target element(s) in the high definition image 110.

If the user(s) does not detect the additional element at block 212, the system may re-display the image 110. The system 200 may subsequently display the high definition image 110 in a third state, as shown at block 220. Alternatively the system 200 may re-display the high definition image 110 in a first state as shown at block 202 or the second state as shown in block 210.

In the third state 220, the system displays and magnifies one or more portions of the high definition image 110, such that details of the high definition image 110 that were not readily available in the first state 202 are now viewable. The portion of the high definition image that is displayed in the third state 220, may be selected by the user(s) or by the system. As will be appreciated by one of ordinary skill in the art, the second state may be triggered automatically by the system, in response to input from the user(s), such as a mouse click, a keystroke, gesture, or activation of a touch-sensitive surface, in response to the system's pre-set instructions, and/or any other appropriate trigger.

At block 222, the user(s) determines whether he/she detects the target element. If the user does not detect the target element, the system may subsequently display the high definition image in a third state, as shown at block 220. As will be appreciated by one of ordinary skill in the art, the third state may be triggered automatically by the system, in response to input from the user(s), such as a mouse click, a keystroke, or tap on a touch-sensitive surface, in response to the system's pre-set instructions, and/or any other appropriate trigger. In the third state 213, the system displays and magnifies one or more portions of the high definition image, such that details that were not readily available in the second state 210 are now viewable. The portion of the high definition image that is displayed in the second state 220, may be selected by the user(s) or by the system.

After the system displays the high definition image in the third state 220, the user(s) determines whether a target element is detected in the displayed portion(s) of the high definition image at block 222. Again, the user(s) may determine whether the target element is present by visually analyzing the image, or digitally processing the image using image recognition software and/or any other means, including diagnostic software.

If the user detects the target element, at block 222, the system 200 may reward the user at block 228 by providing a free product or service, discount for certain products or services, points, and/or any other suitable reward. The system 200 may end the application, direct the user(s) to a different high definition image, or direct the user(s) to identify additional target element(s) in the high definition image 110. If the user does not detect the target element at block 222, the system 200 may subsequently return the high definition image 110 to its first state 200, its second state 210, or any other appropriate state, whereby the process begins again.

While the previous example illustrates a system 200 capable of displaying a high definition image 110, and portions thereof in three states 202, 210, 220, one of ordinary skill in the art will recognize that the disclosure may comprise any number of states as the system may desire. Further, while the previous example illustrates the search for one target element, the disclosed system may comprise as many target elements as the system may desire (e.g., a scavenger hunt). The system 200 may be utilized by one user, or a group of users. A group of users may search for the target elements collectively by simultaneously viewing the same images (e.g., image 110), and viewing the images at the same state (e.g., states 202, 210, or 220) on separate devices 20, such as personal computers, mobile devices, cellular phones, personal digital assistant (PDA)s, retail kiosks, and/or physical mediums using, such as, for example, the Internet, an internal network, or a social network. In another example, a group of users may search for the target elements collectively by independently viewing the high definition image on separate devices 20. In another example of the present disclosure, a group of users may utilize the system by competing against one another to find the target element(s). In yet another example of the present disclosure, the user may activate the high definition image, and/or the target elements by, for example, inputting coupon codes, inputting product receipts, sharing content with other users, sharing content via a social networking site, answering a clue provided by the system, purchasing a product, signing up for an organization's newsletter, creating a profile in a system's database, signing up for a financial service, making a post on a social networking site, publishing a review of certain goods and/or services, and/or performing any other appropriate act. The system 200 may be used in a gaming application, a training application, a team-building application, a promotional application, and/or any other appropriate application.

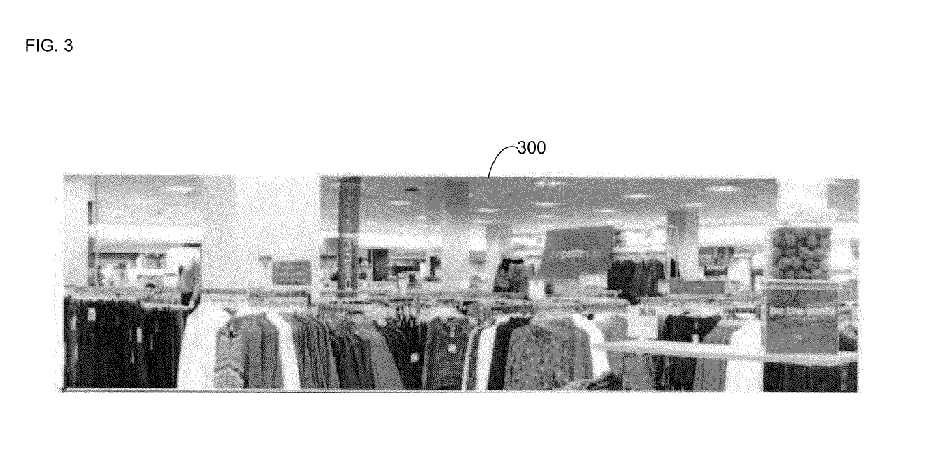

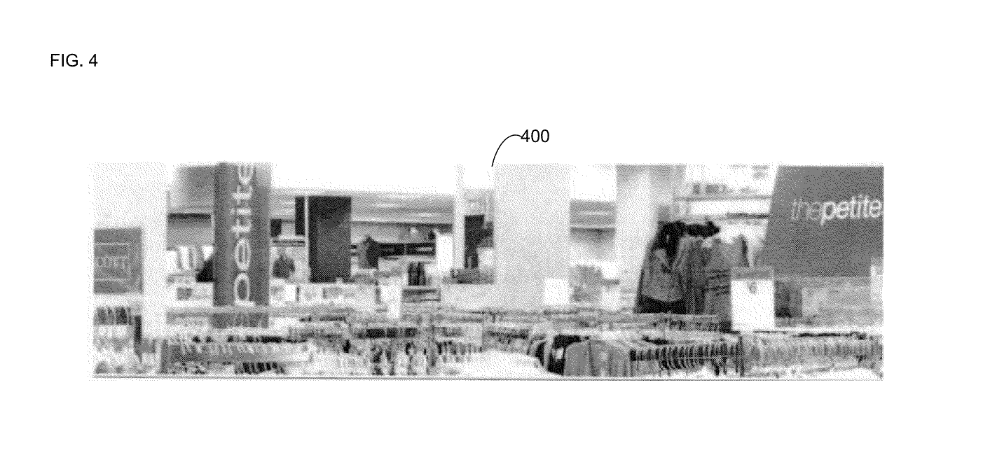

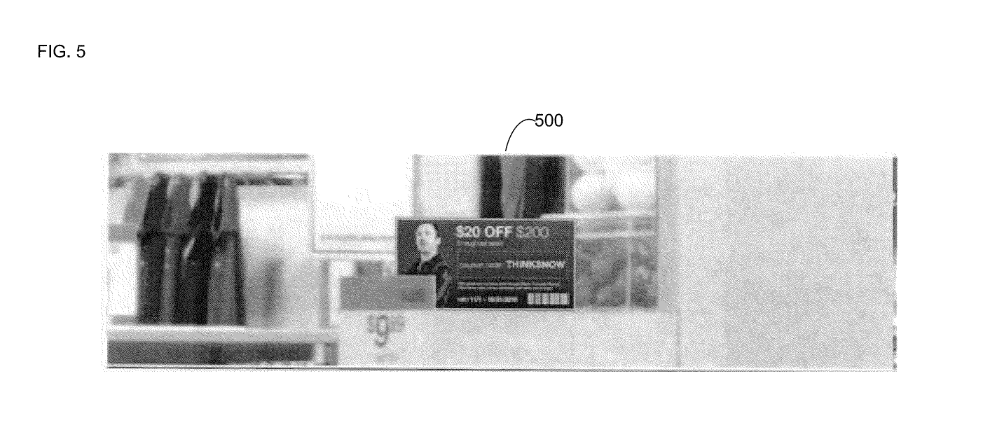

FIGS. 3-30 illustrate screenshots of an example system 200 utilizing high definition images. In FIG. 3, a screenshot 300 depicts a high definition image 110 in a first state, wherein the entire high definition image is visible. In FIG. 4, a screenshot 400 depicts a high definition image in a second state 400, wherein a portion of a high definition image is magnified, revealing details that were previously not apparent in the screenshot 300 of the high definition image in the first state. In FIG. 5, a screenshot 500 depicts a high definition image in a third state, wherein a portion of a high definition image is further magnified, revealing details that were previously not apparent in the screenshots 300 and 400 of the high definition image in the first state and second states. Moreover, the screenshot 500 of the high definition image in its third state comprises a possible target element. Such target element was not apparent in the screenshots 300 and 400 of the high definition image in its first and second states.

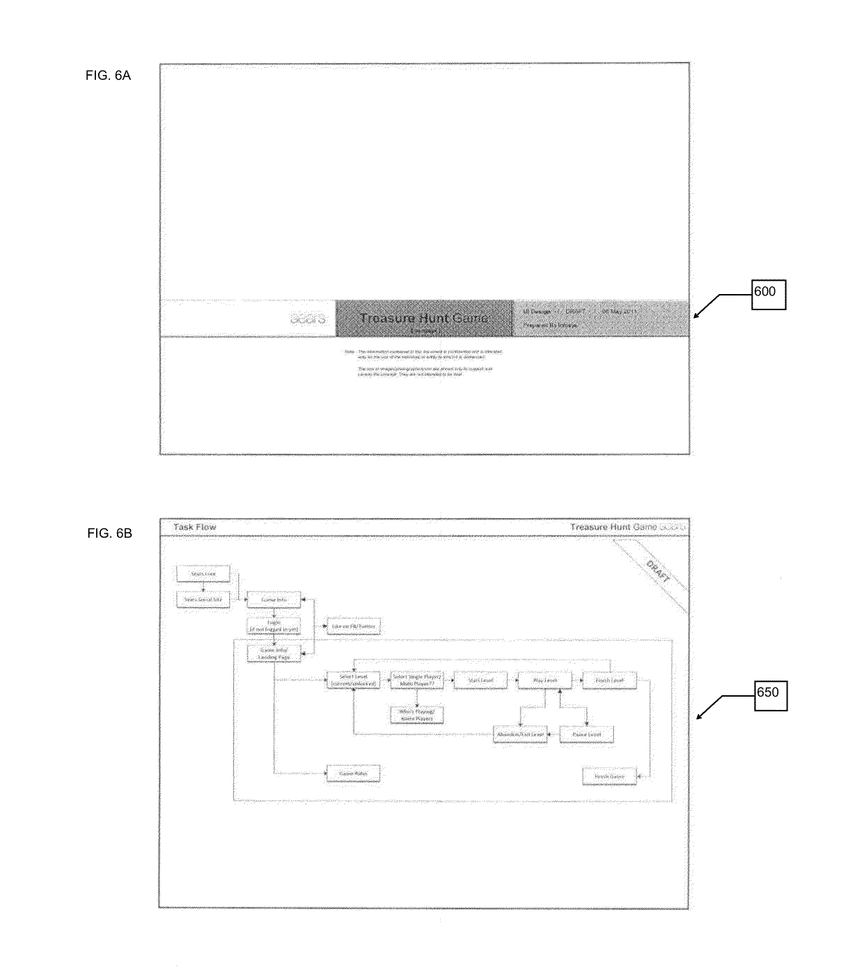

In FIG. 6A, a screenshot 600 depicts a system 200 that may include an opening title page, introductory page, and/or any other appropriate page. Additionally, as depicted in screenshot 600 the system 200 may be used by a corporation, and/or a retail outlet. In FIG. 6B, a screenshot 650 depicts a possible task flow chart that may describe the task flow of the system 200.

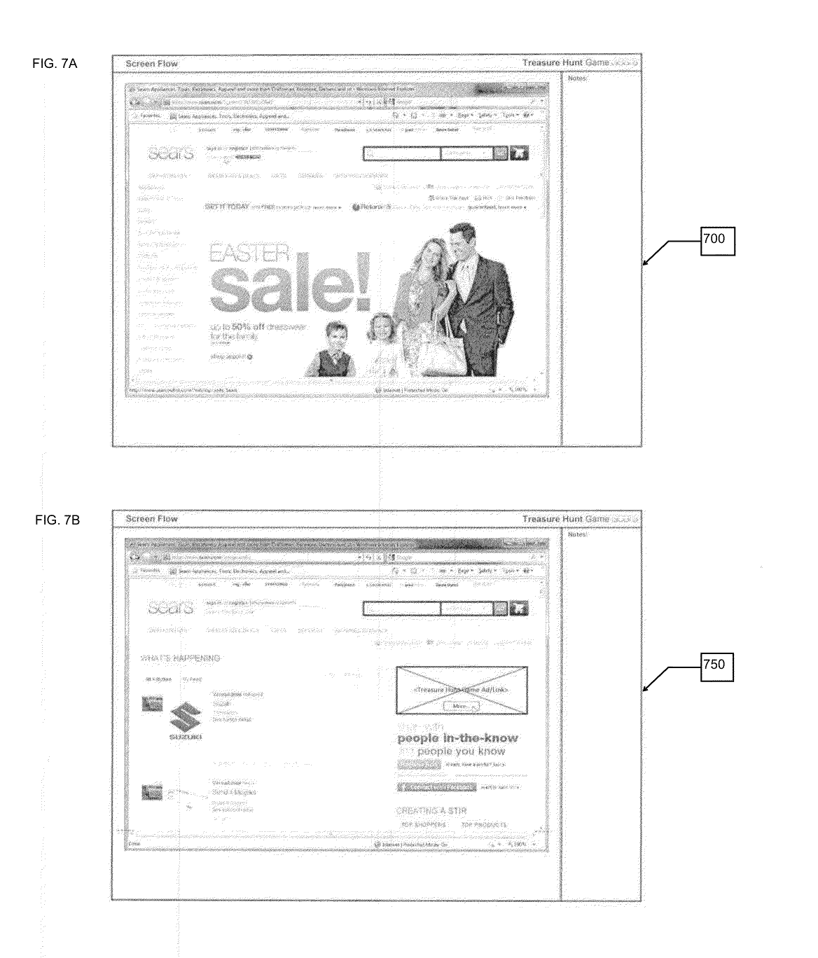

In FIG. 7A, a screenshot 700 demonstrates that the system 200 may be accessed from an organization's website, such as a retail web site. In FIG. 7B, a screenshot 750 demonstrates that the system 200 may be accessed from a restricted area of the website, which may only be available to certain customers, long-time users, customers with a certain password, or based on any other restriction that may be appropriate.

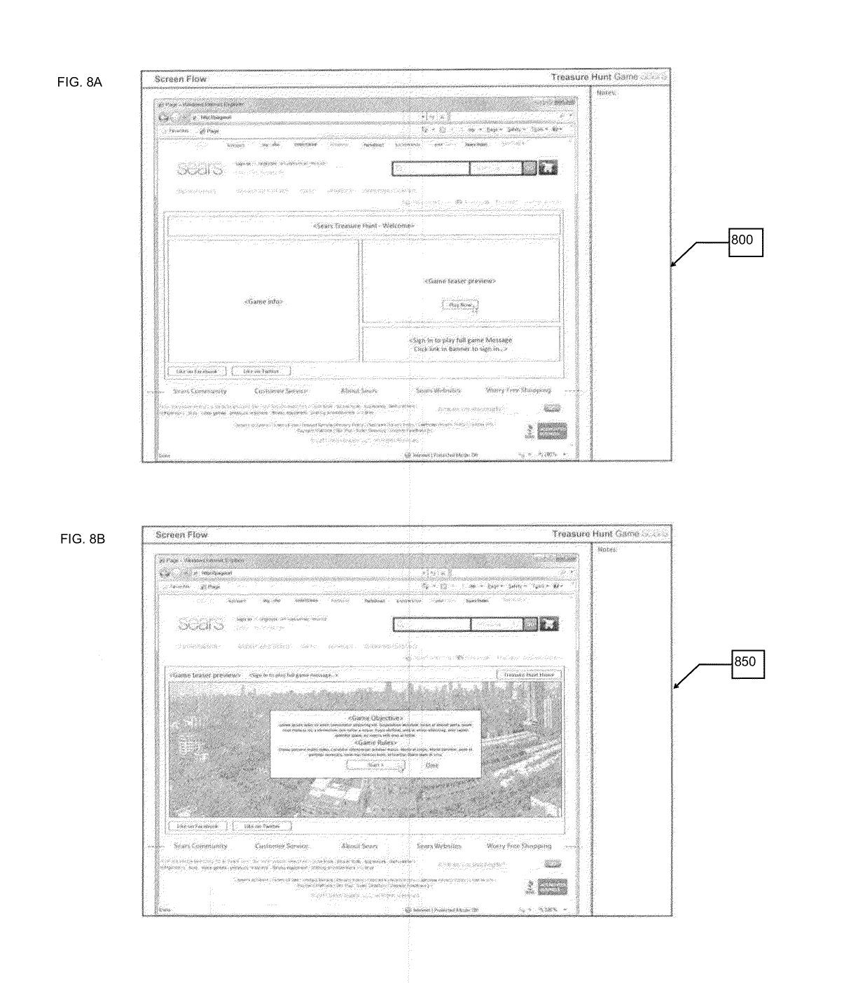

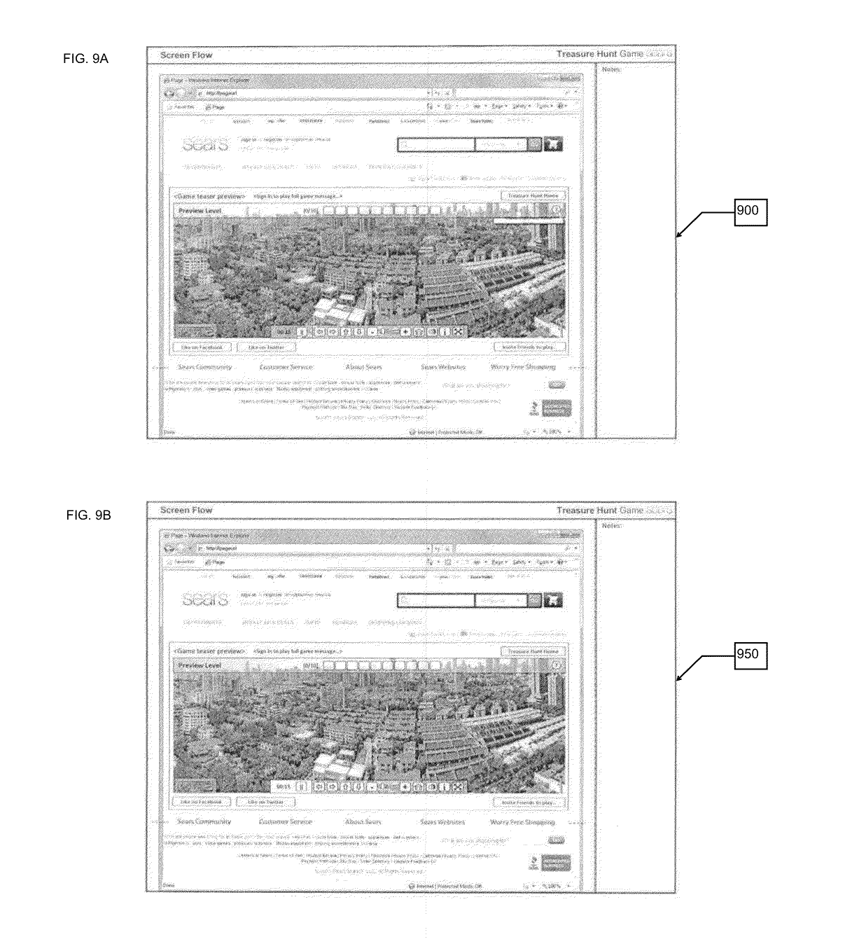

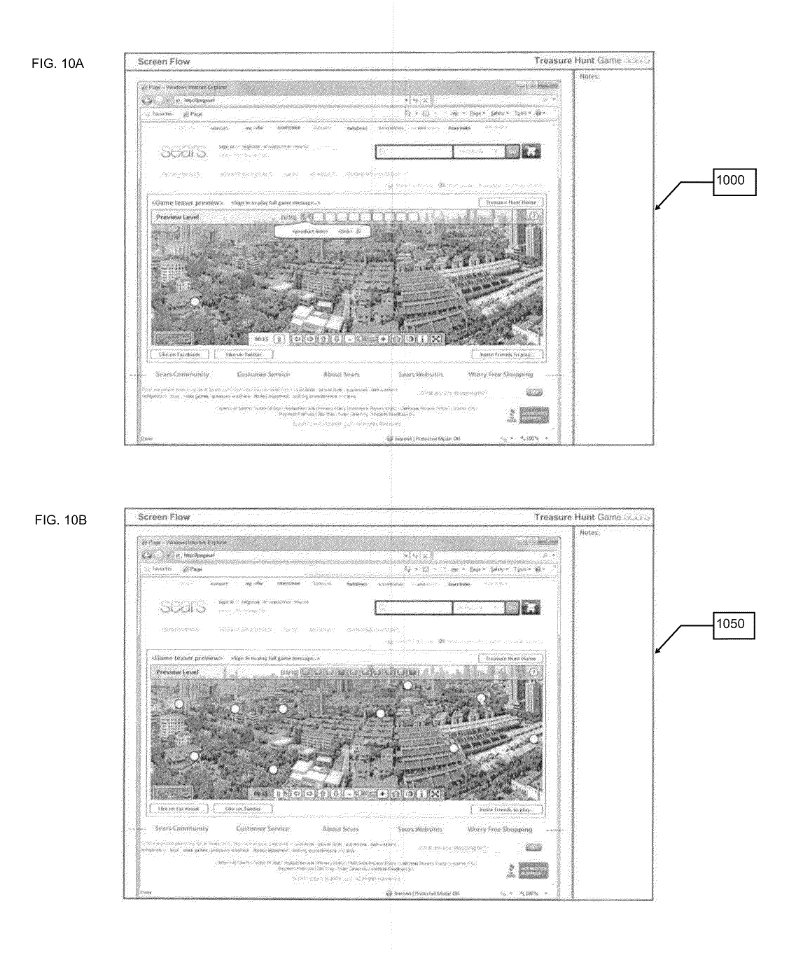

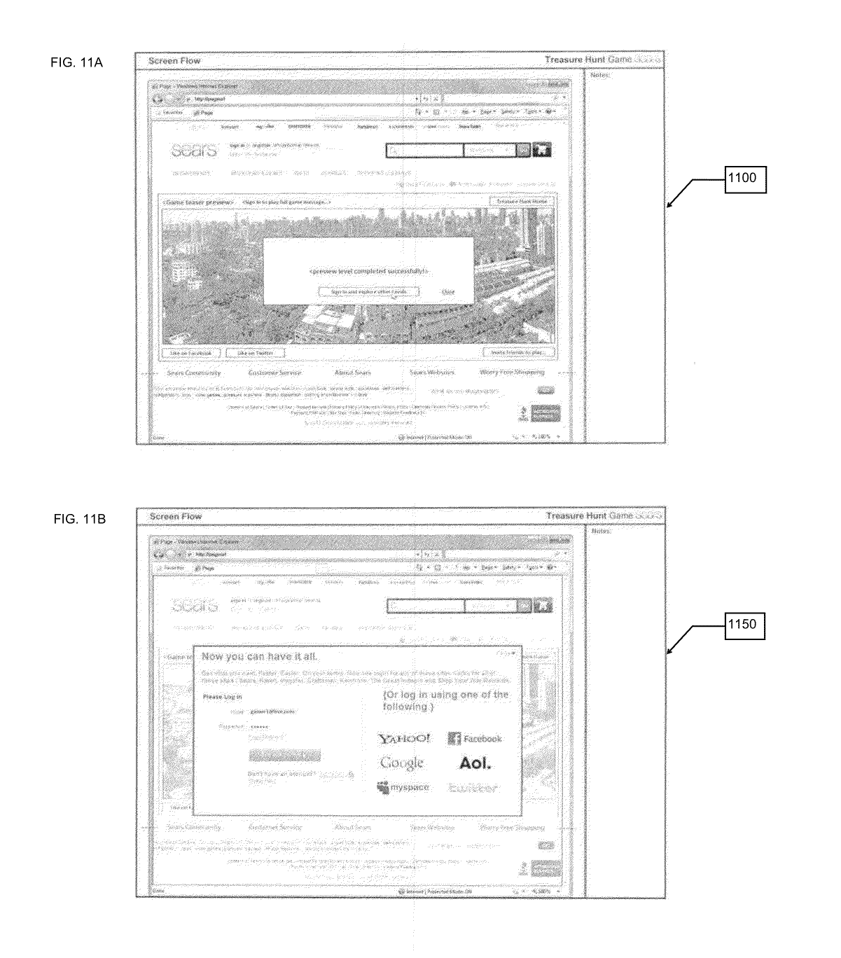

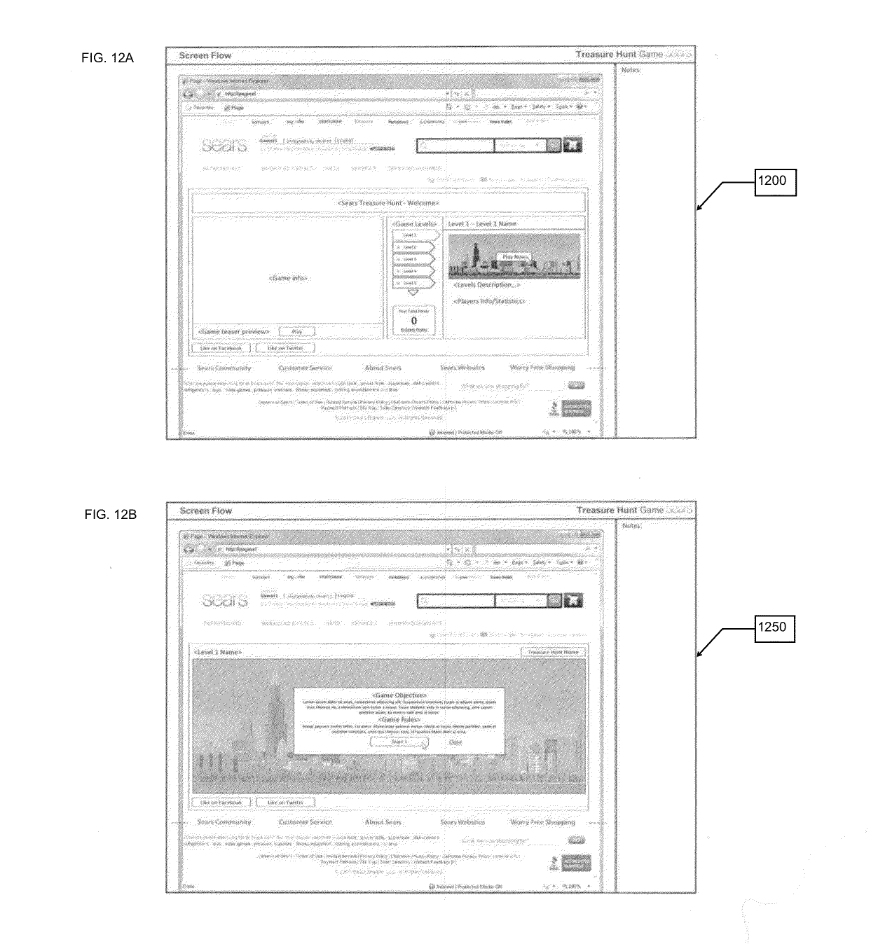

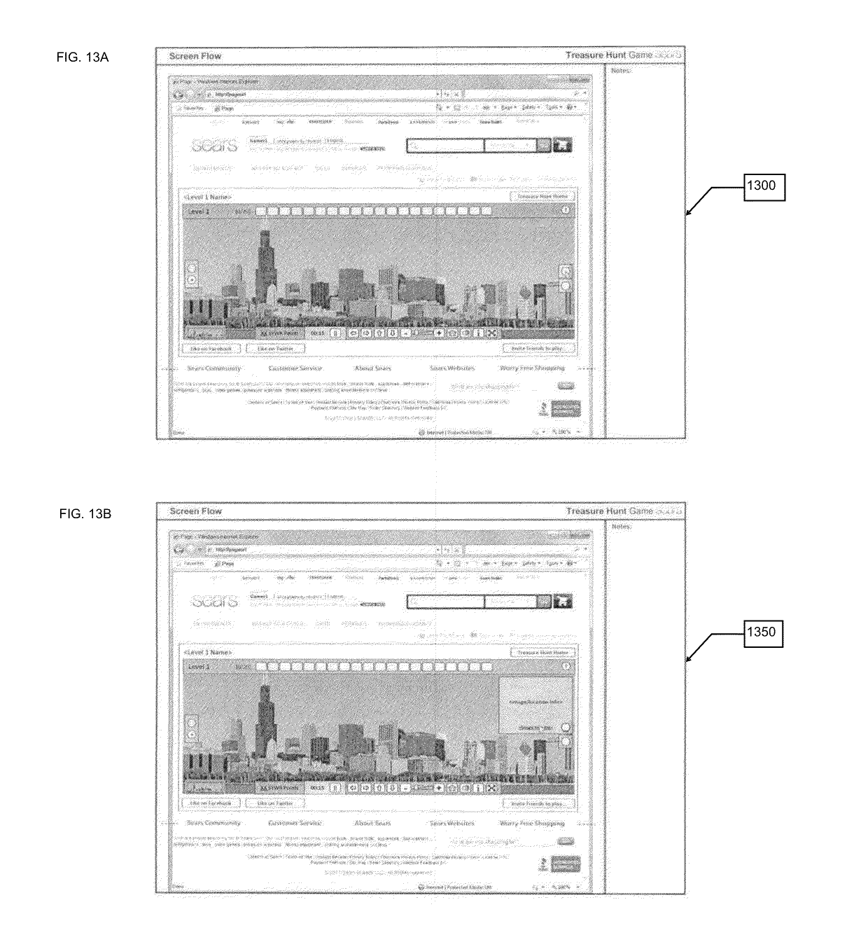

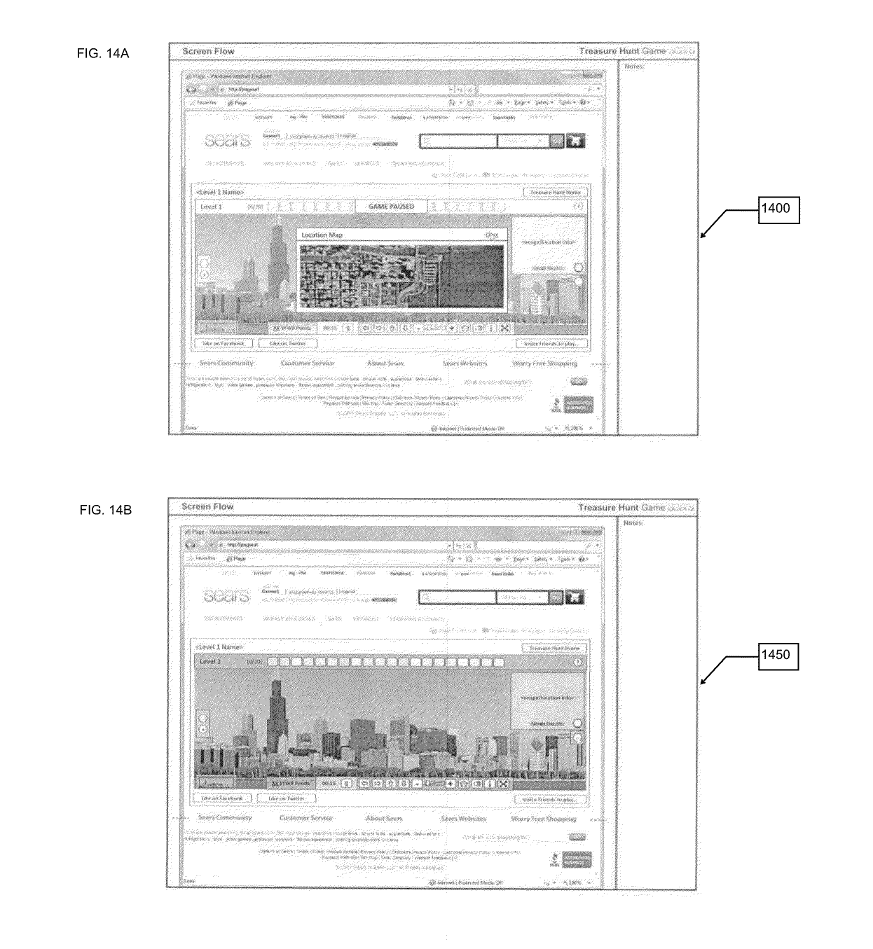

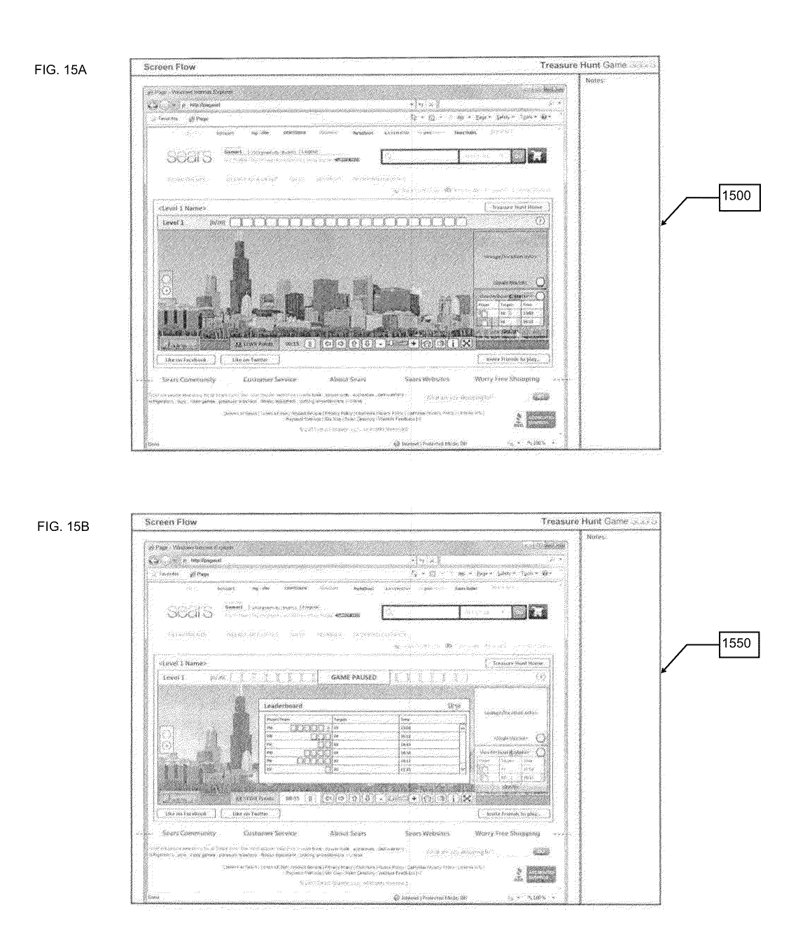

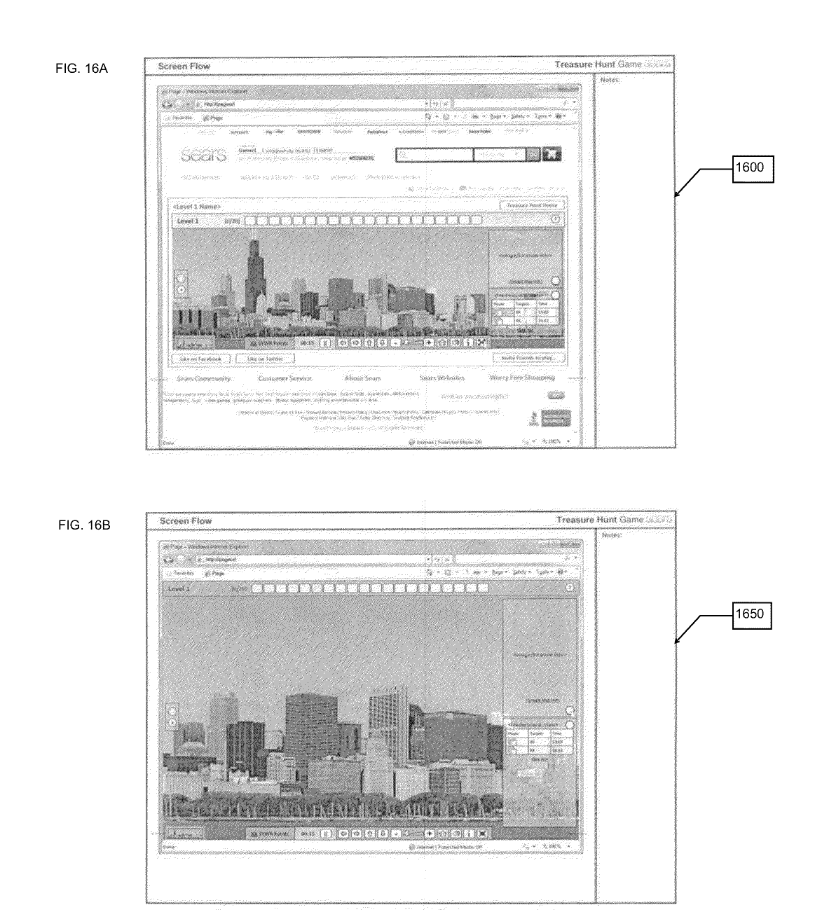

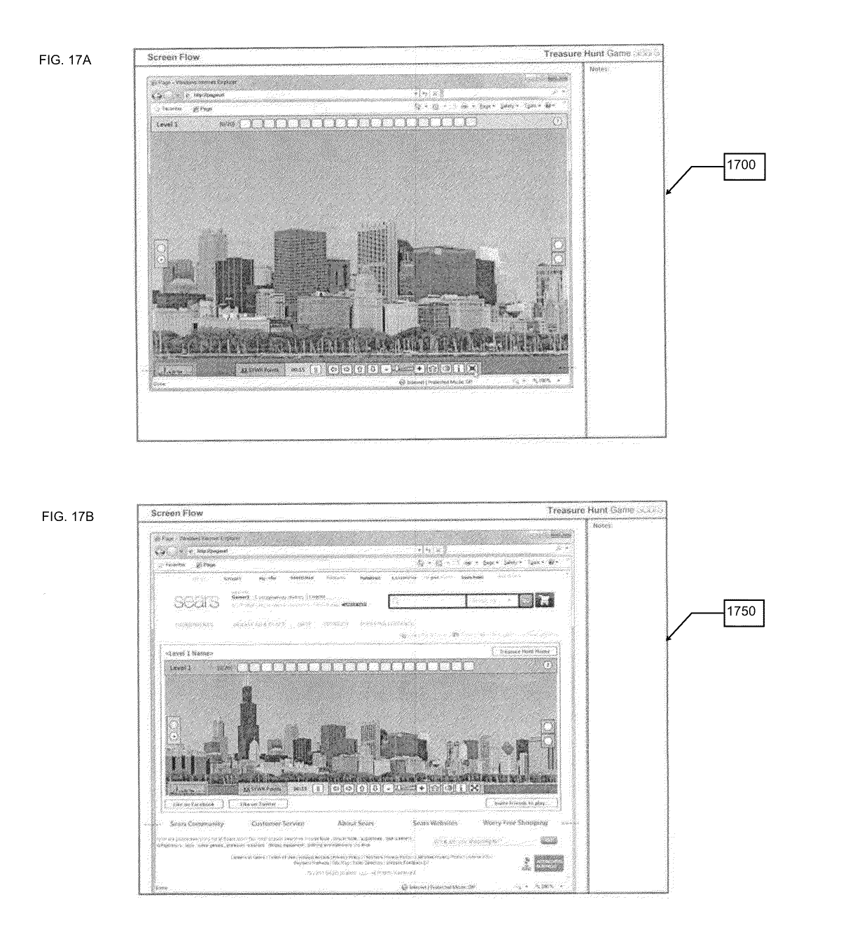

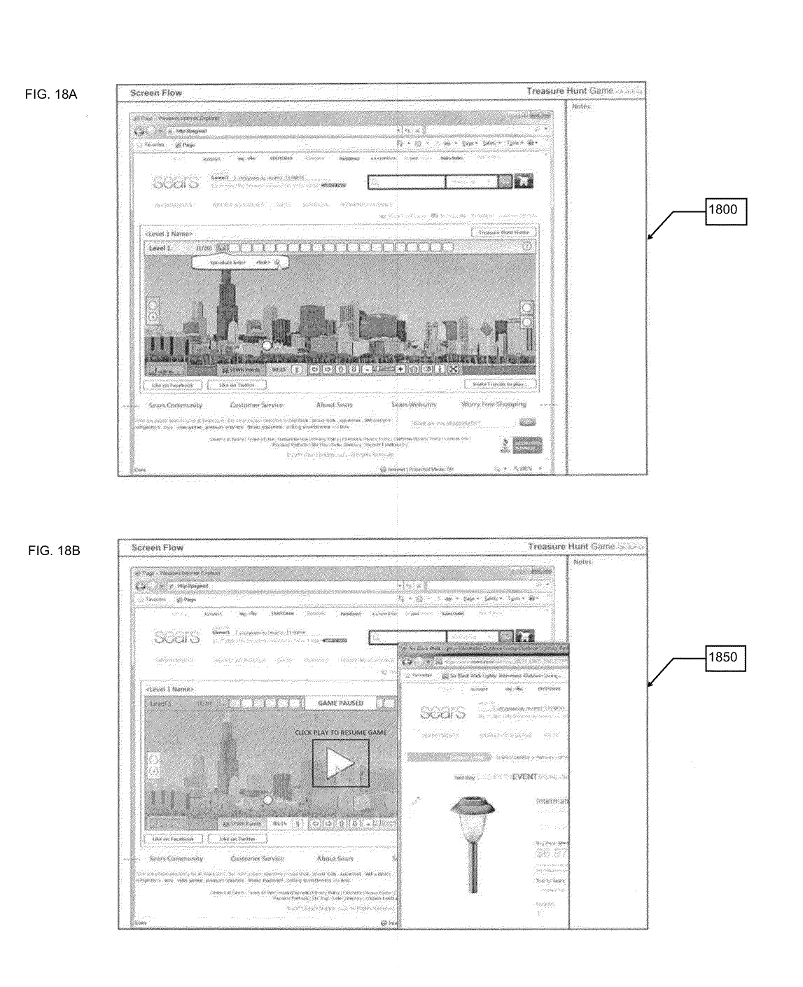

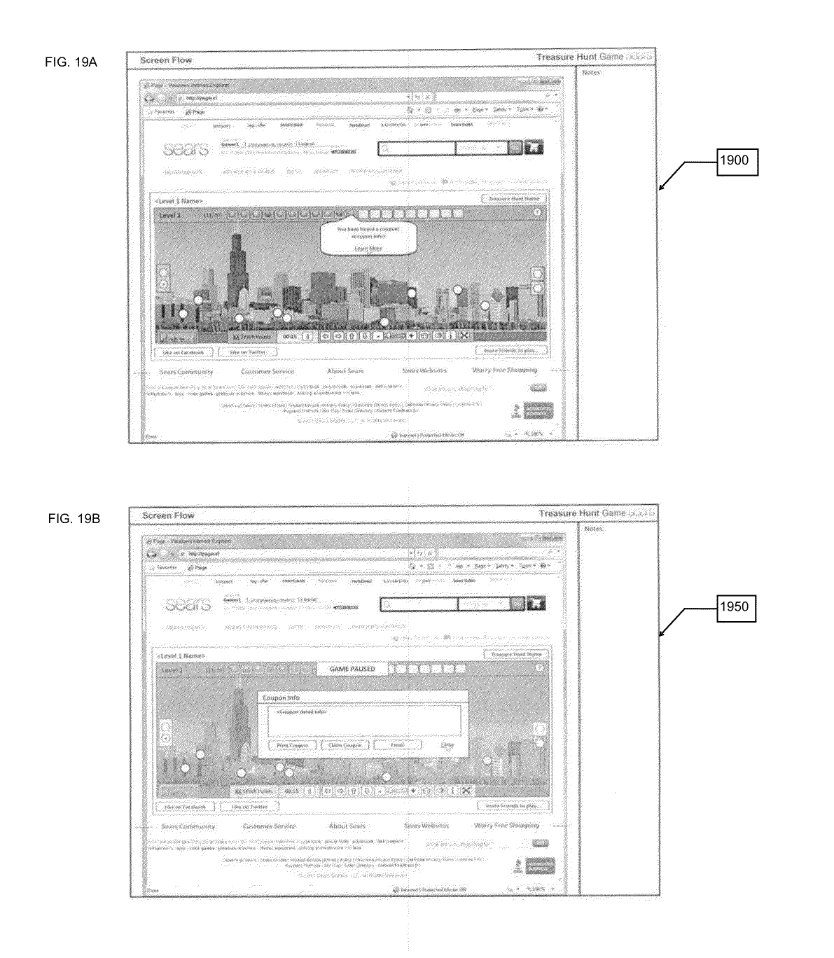

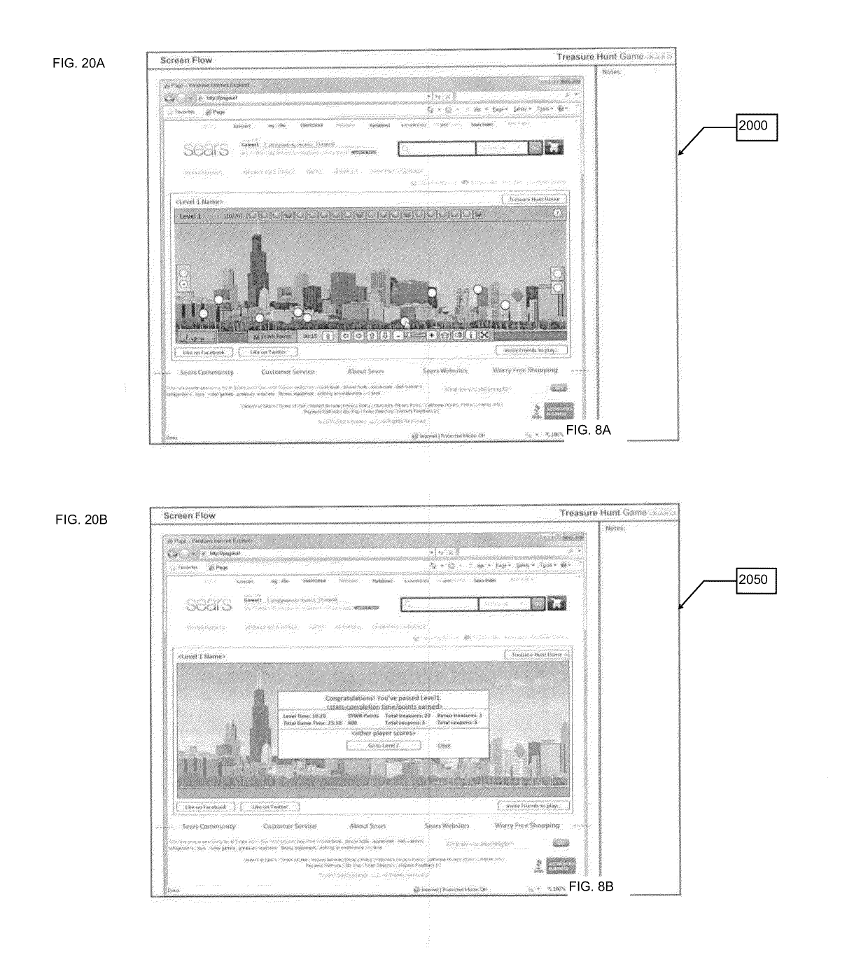

In FIG. 8A, a screenshot 800 depicts a system 200, wherein the system comprises a preview state. In FIG. 8B, a screenshot 850 depicts a system 200 that displays a game objective.

In FIG. 9A, a screenshot 900 depicts a system 200 wherein the system 200 displays a high definition image of an urban landscape, and wherein the system 200 allows a user to zoom in and out of the image. In FIG. 9B, a screenshot 950 depicts a system 200 wherein the system 200 utilizes a timer. Additionally, as shown in screenshot 950 a system 200 comprises buttons that allow a user to navigate upward, downward, left and right on the high definition image.

In FIG. 10A, a screenshot 1000 depicts a system 200 that displays a link to product information when a target element is revealed. In FIG. 10B, a screenshot 1050 depicts a system 200 wherein all the targets in the preview state are revealed.

In FIG. 11A, a screenshot 1100 depicts a system 200 wherein the preview state is completed after all the targets are revealed. In FIG. 11B, a screenshot 1150 depicts a system 200 wherein new levels are revealed after the preview state is completed.

In FIG. 12A, a screenshot 1200 depicts a system 200 comprising a welcome screen that displays a plurality of levels of the game. In FIG. 12B, a screenshot 1250 depicts a system 200 wherein game objectives and game rules are displayed.

In FIG. 13A, a screenshot 1300 depicts a system 200 comprising a screen that displays a high definition image of an existing location, and the system 200 further gives users a plurality of view options. In FIG. 13B, a screenshot 1350 depicts a system 200 wherein a user may choose to view a map of the location depicted in the high definition image.

In FIG. 14A, a screenshot 1400 depicts a system 200 that displays a map of the landscape shown in the high definition image. In FIG. 14B, a screenshot 1450 depicts a system wherein a user may choose to display a leaderboard showing the scores of other users of the system 200.

In FIG. 15A, a screenshot 1500 depicts a system 200 that displays an abbreviated leaderboard showing the scores of other users of the system 200. In FIG. 15B, a screenshot 1550 depicts a system 200 that displays a full-sized leaderboard showing the scores of other users of the system 200.

In FIG. 16A, a screenshot 1600 depicts a system 200 comprising a button that displays the high definition image in full screen. In FIG. 16B, a screenshot 1650 depicts a system 200 wherein the high definition image is displayed in full screen.

In FIG. 17A, a screenshot 1700 depicts a system 200 wherein the high definition image is displayed in full screen, and the system 200 also comprises a button that causes the system to display the high definition in a minimized format. In FIG. 17B, a screenshot 1750 depicts a system 200 comprising buttons that allow a user to share or comment on the system 200 via a social networking site such as Twitter or Facebook.

In FIG. 18A, a screenshot 1800 depicts a system 200 wherein the system 200 gives users an option to view an organization's product information appears after a first target element has been identified. In FIG. 18B, a screenshot 1850 depicts a system 200 that links to a product webpage, and pauses the target searching game, while a user views the product webpage.

In FIG. 19A, a screenshot 1900 depicts a system 200 that offers a coupon after a user identifies a certain target element. In FIG. 19B, a screenshot 1950 depicts a system 200 wherein coupon information appears on the screen after a user identifies a certain target element.

In FIG. 20A, a screenshot 2000 depicts a system 200 wherein the revealed target elements are identified using icons on the high definition image. In FIG. 20B, a screenshot 2500 depicts a system 200 wherein a level is completed after a certain number of target elements are revealed. As shown in FIG. 20B, a user is rewarded with reward points, and a user is shown the amount of time he or she took to complete the level, after the requisite target elements have been revealed.

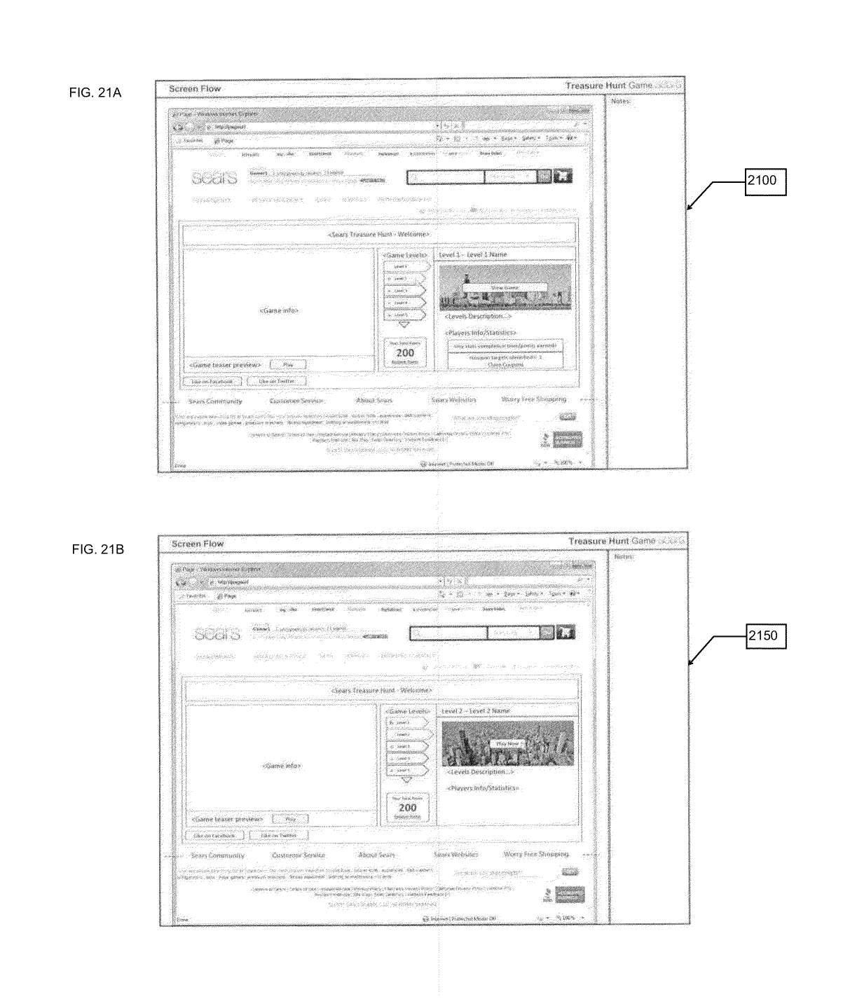

In FIG. 21A, a screenshot 2100 depicts a system 200 wherein a user may view a plurality of game levels, and the user may view a preview of a selected game level. In FIG. 21B, a screenshot 2150 depicts a system 200, wherein a user may select a certain game level to engage in.

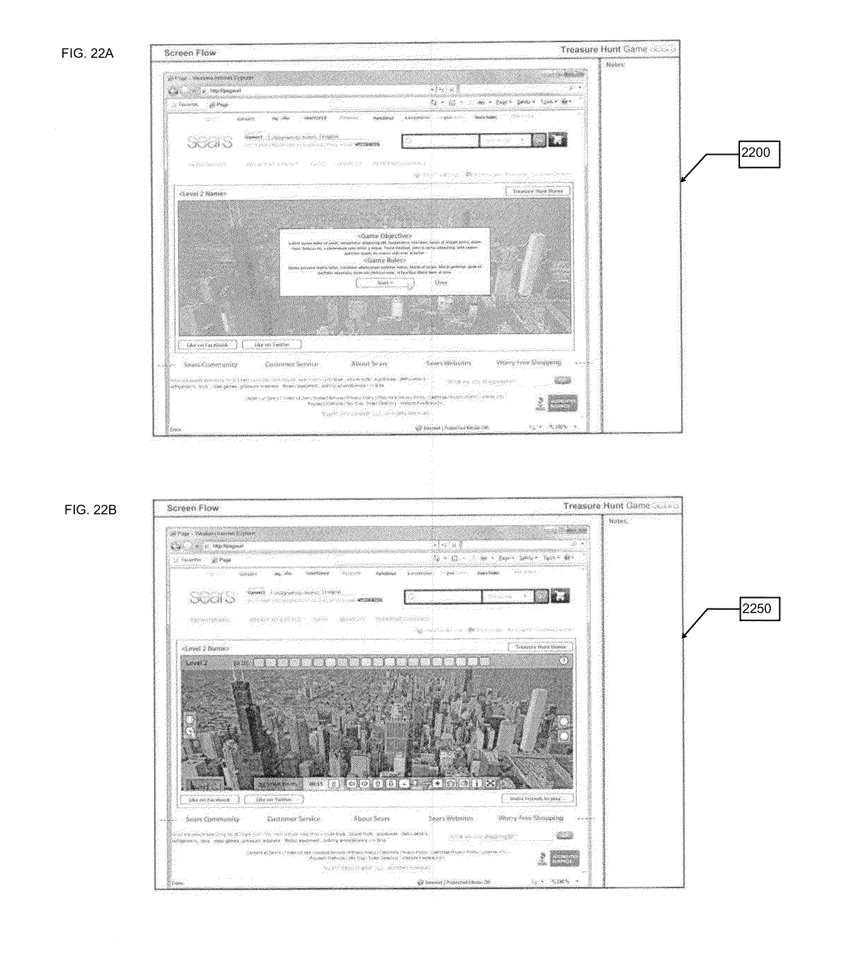

In FIG. 22A, a screenshot 2200 depicts a system 200 that displays game objectives and game rules when user begins a new level. In FIG. 22B, a screenshot 2250 depicts a system 200 comprising a button that allows a user to send invitations to additional users to participate in the system 200.

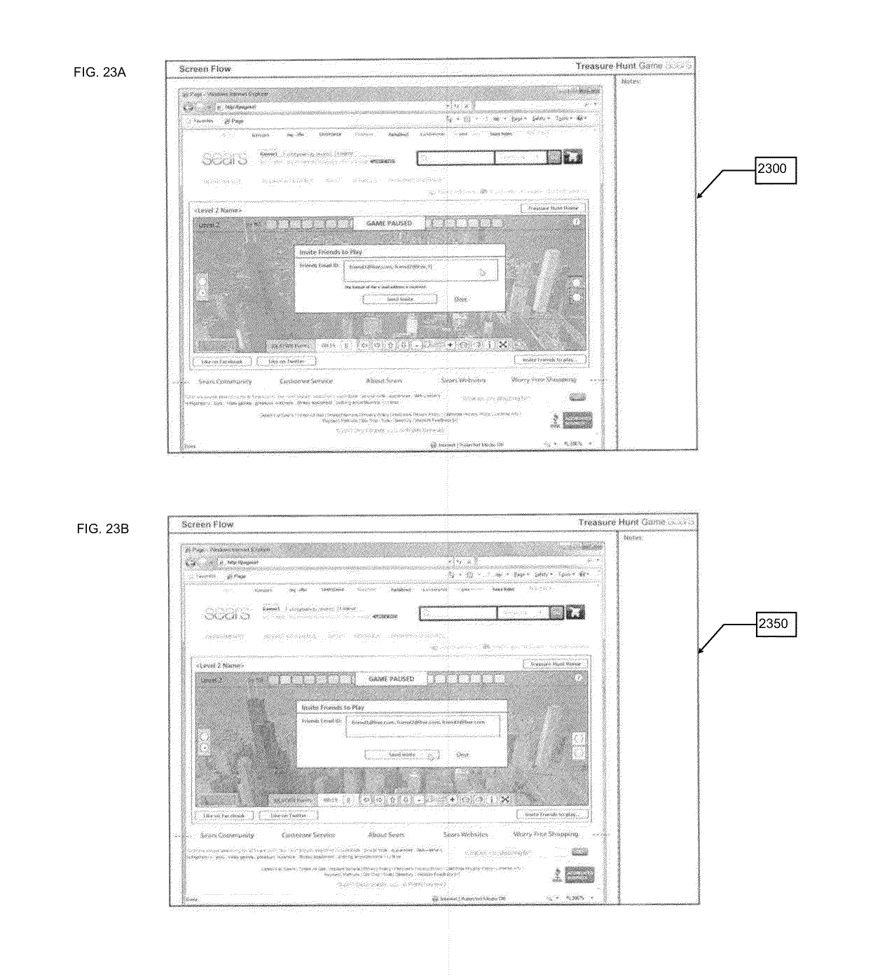

In FIG. 23A, a screenshot 2300 depicts a system 200 comprising a window that allows users to enter the contact information for additional users. In FIG. 23B, a screenshot 2350 depicts a system 200 wherein invitations are sent to additional users after a user enters contact information for the additional users and directs the system 200 to send invitations to the additional users.

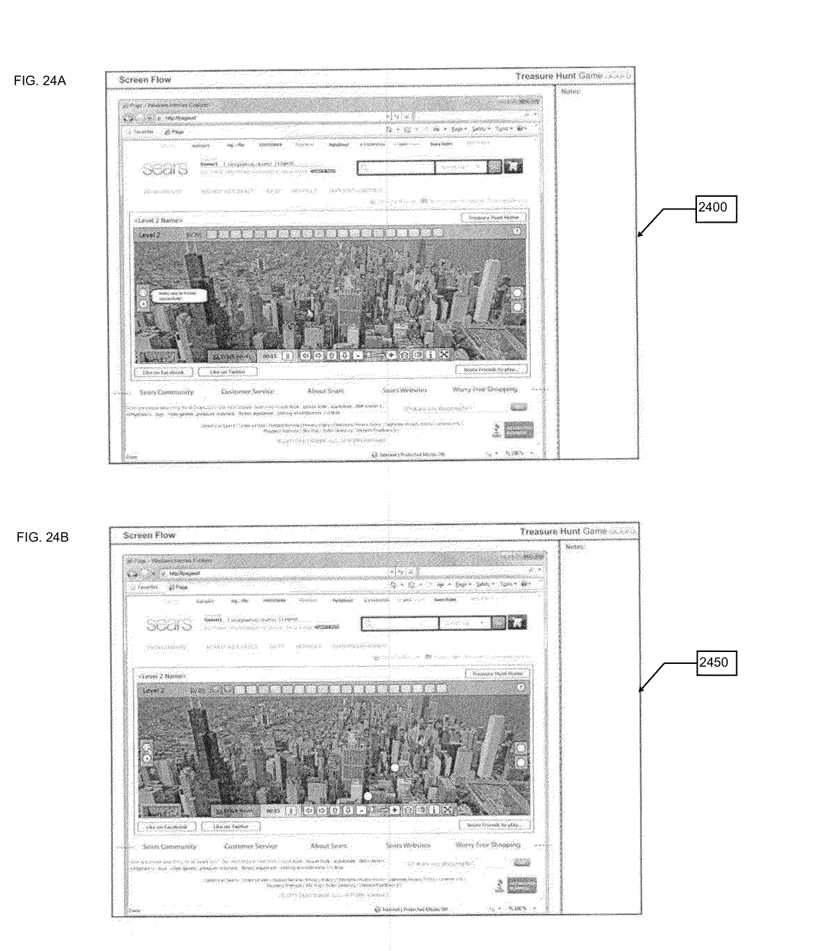

In FIG. 24A, a screenshot 2400 depicts a system 200 wherein the system displays a message after invitations are successfully sent to additional users. In FIG. 24B, a screenshot 2450 depicts a system 200 wherein the system displays an icon corresponding to target elements that have been revealed.

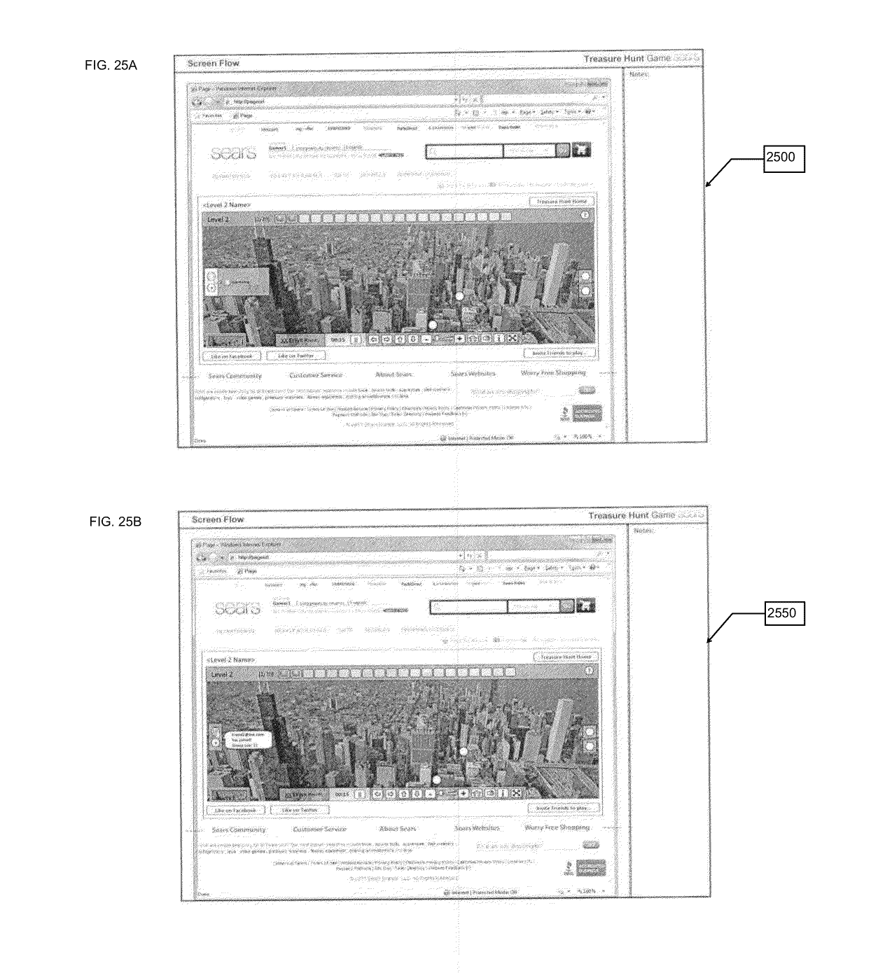

In FIG. 25A, a screenshot 2500 depicts a system 200 wherein a user may view statistics for an additional user, such as the number of target elements that the additional user has identified. In FIG. 25B, a screenshot 2550 depicts a system 200 wherein a user is notified when an additional user has joined his or her group, and the system 200 notifies the user of the group size.

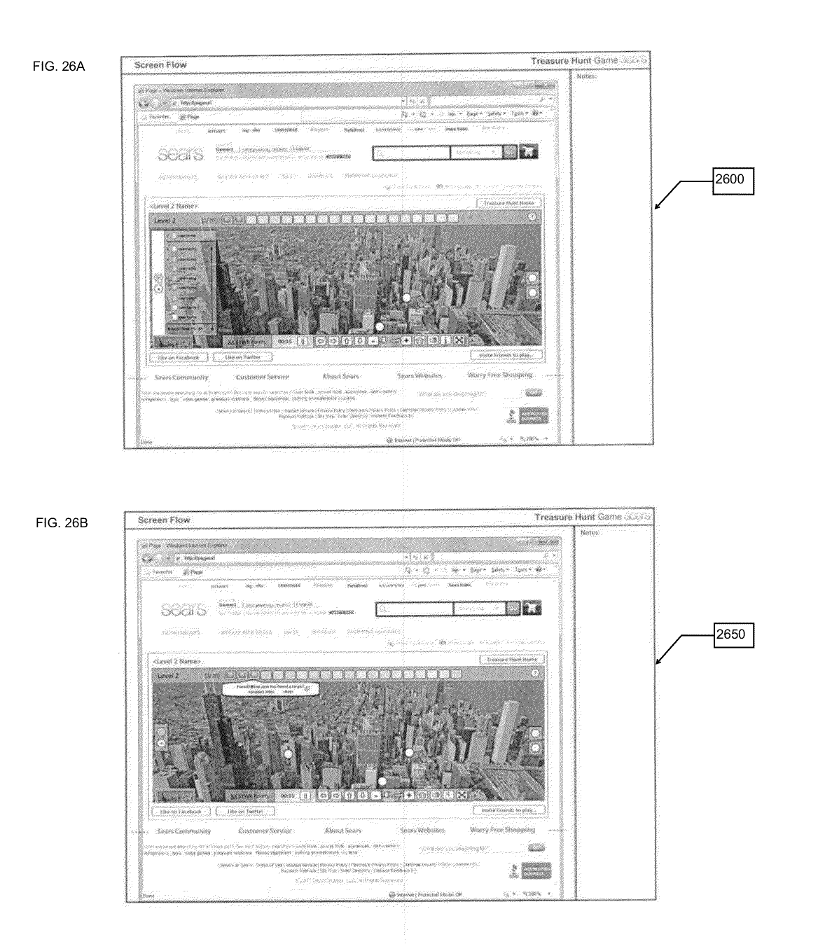

In FIG. 26A, a screenshot 2600 depicts a system 200 wherein a user may view all additional users that are members of his or her group, and the user may view statistics about the additional users that are in his or her group, such as the number of target elements each additional user has identified. In FIG. 26B, a screenshot 2650 depicts a system 200 wherein the user is notified when an additional user has identified a target element.

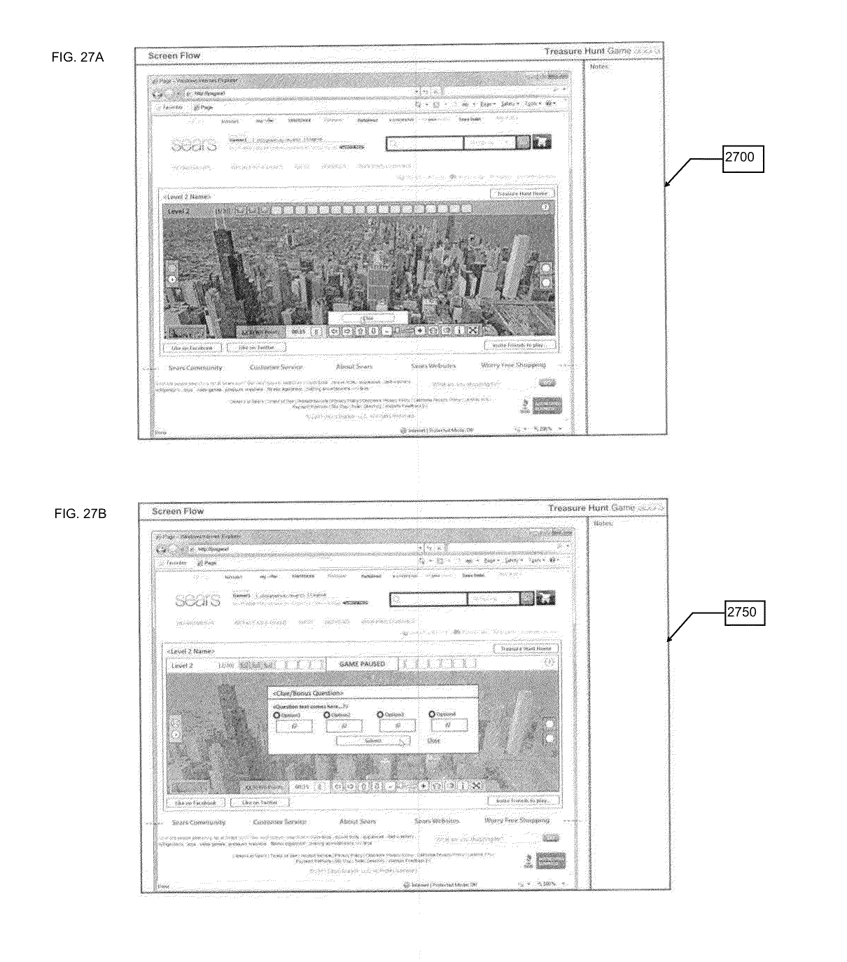

In FIG. 27A, a screenshot 2700 depicts a system 200 wherein a user may choose to receive a clue and/or bonus question to further the user's game objectives. In FIG. 27B, a screenshot 2750 depicts a system 200 wherein the system 200 gives a user a multiple choice question as a bonus and/or clue question.

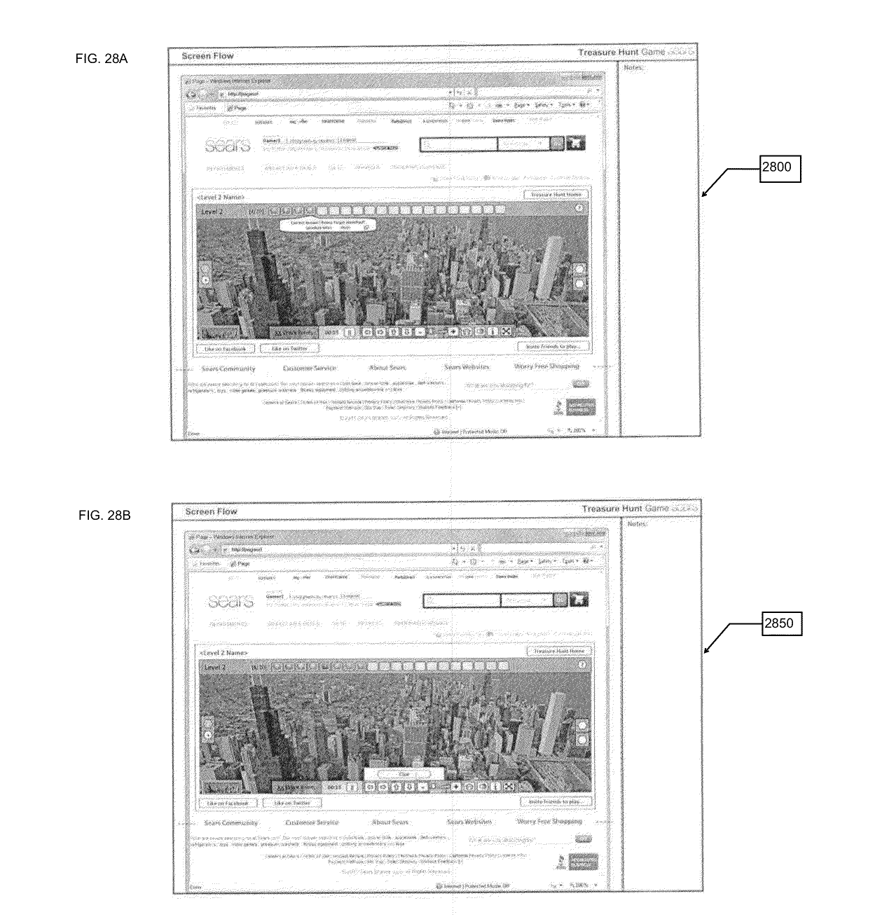

In FIG. 28A, a screenshot 2800 depicts a system 200 wherein a user answers a bonus and/or clue question correctly, and the user is rewarded by receiving the location of a target element. In FIG. 28B, a screenshot 2850 depicts a system 200 wherein a user may choose to receive a clue and/or bonus question to further the user's game objectives.

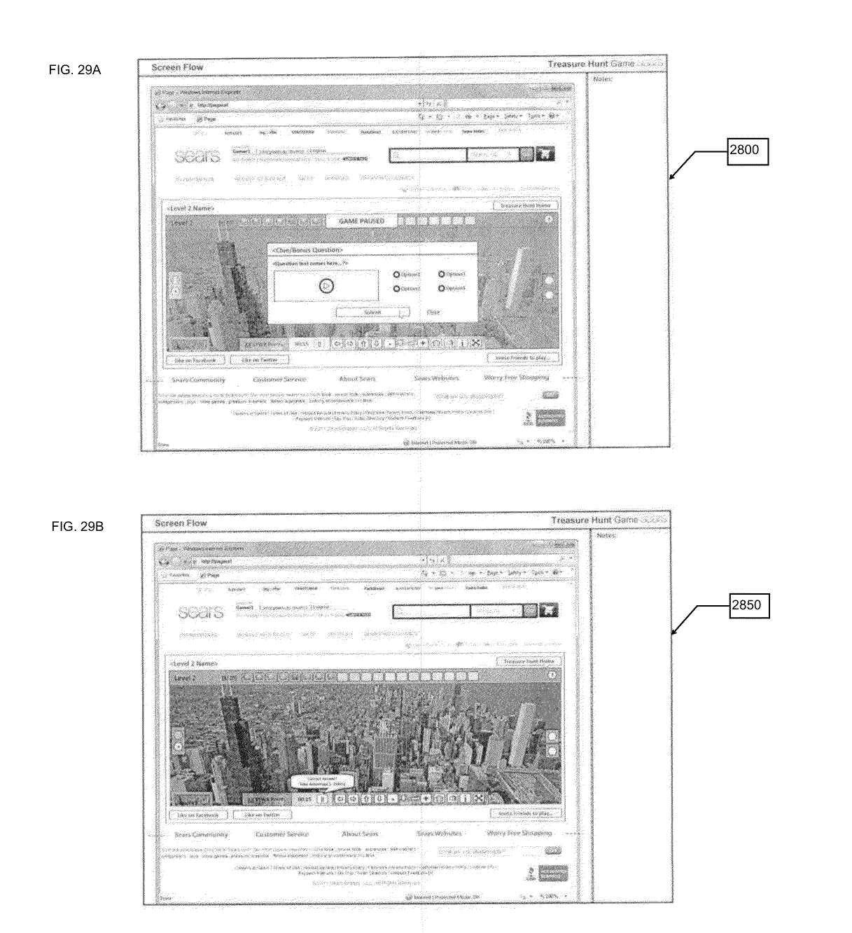

In FIG. 29A, a screenshot 2900 depicts a system 200 wherein a user may answer a question in order to receive a clue and/or bonus question, and the clue and/or bonus question may comprise a video segment. In FIG. 29B, a screenshot 2950 depicts a system 200 wherein a user answers a bonus and/or clue question correctly, and the user is rewarded by receiving additional time to complete the level.

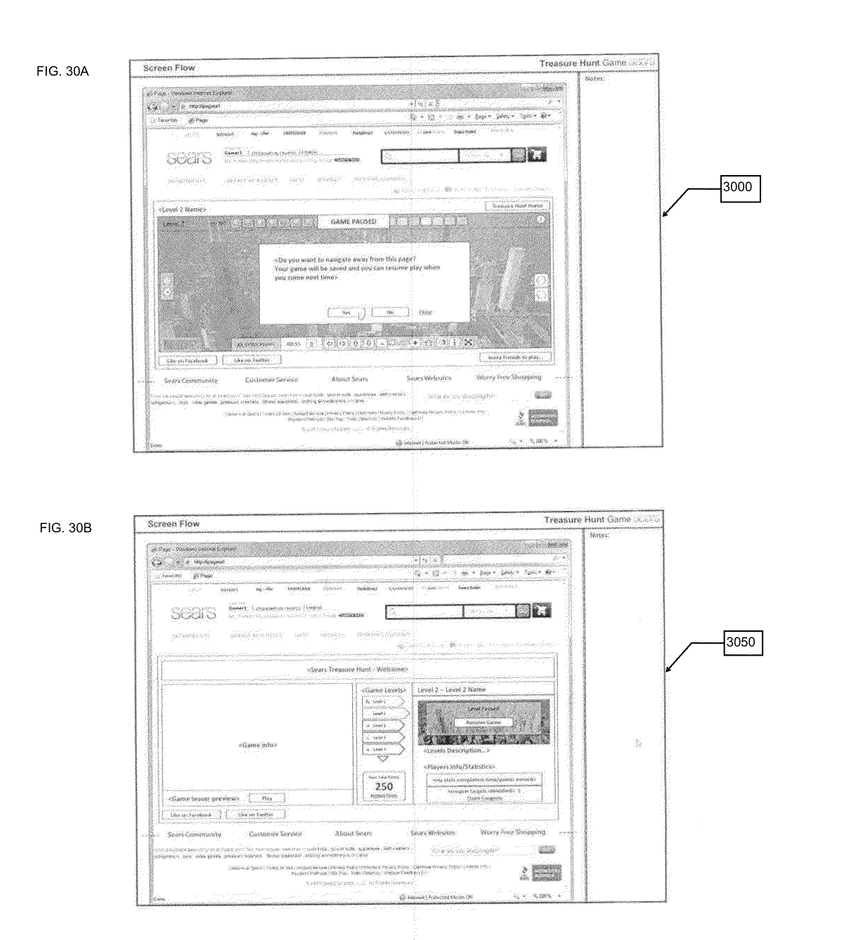

In FIG. 30A, a screenshot 3000 depicts a system 200 that displays a warning message before a user navigates away from the website hosting the system 200. In FIG. 30B, a screenshot 3500 pauses the game play while a user is absent from the system 200.

We claim:

1. A method for utilizing high definition images, comprising:
storing a high definition image;
concealing at least one hidden target element within the high definition image;
directing at least one user to view the high definition image and identify the at least one hidden target element in the high definition image;
changing the resolution of the high definition image; and
revealing the hidden target element within the high definition image.

2. A method as recited in claim 1, wherein the at least one user is rewarded whenever the at least one user detects the at least one target element.

3. A method as recited in claim 1, wherein the at least one high definition image comprises at least one billion pixels.

4. A method as recited in claim 1, wherein the at least one user is selected based on stored information related to the first user.

5. A method as recited in claim 1, wherein the method utilizing high definition images further comprises allowing the at least one user to select the portion of the high definition image to view in the at least first state, wherein a selected portion of the high definition image is magnified.

6. A method as recited in claim 5, wherein the method utilizing high definition images further comprises at least a second state wherein a portion of the high definition image is magnified to a greater degree than the magnification of the at least a first state.

7. A method as recited in claim 1 wherein the method utilizing high definition images further comprises utilizing a timer to track the amount of time it takes the at least one user to identify at least one target element.

8. A method as recited in claim 1, wherein the method utilizing high definition images further comprises directing at least a second user to identify the at least one hidden target element in the high definition image.

9. A method as recited in claim 8, wherein only the at least second user is rewarded whenever the at least second user detects the at least one target element.

10. A method as recited in claim 8, comprising rewarding the first of the at least first user, and the at least second user to detect the at least one target element.

11. A method as recited in claim 8, wherein both the first of the at least first user, and the at least second user are rewarded when the at least one target element is detected.

12. A computer-readable media having stored thereon computer executable instructions wherein the instructions perform steps for utilizing high definition images via a computer network, comprising:
hosting a database containing at least one high definition image, wherein at least one target element is embedded in the at least one high definition image;
displaying the at least one high definition image in at least a first state wherein a portion of the at least one high definition image is magnified;
allowing at least one user to view the at least one high definition image; and
directing the at least one user to view the at least one high definition image and detect the at least one target image embedded in the at least one high definition image.

13. A computer-readable media as defined in claim 12, further comprising computer executable instructions rewarding the at least one user when the user detects the at least one target image.

14. A computer-readable media as defined in claim 12, further comprising computer executable instructions selecting based on stored information related to the first user.

15. A computer-readable media as defined in claim 12, further comprising computer executable instructions allowing the at least one user to view the high definition image in at least a first state.

16. A computer-readable media as defined in claim 12, further comprising computer executable instructions allowing the at least one user to select the portion of the high definition image to view in the at least first state, wherein the selected portion of the high definition image is magnified.

17. A computer-readable media as defined in claim 12, further comprising computer executable instructions displaying at least a second state wherein a portion of the high definition image is magnified to a greater degree than the magnification of the at least a first state.

18. A computer-readable media as defined in claim 12, further comprising computer executable instructions allowing at least at least a second user to view the at least one high definition image and to detect the at least one target image embedded in the at least one high definition image.

19. A computer-readable media as defined in claim 18, rewarding whenever the at least second user detects the at least one target element.

20. A computer-readable media as defined in claim 8, rewarding only the first of the at least first user and the at least second user to detect the at least one target element.

21. A computer-readable media as defined in claim 8, rewarding the at least first user, and the at least second user when the at least one target element is detected.
